(19) United States
(12) Patent Application Publication
(10) Pub. No.: US 2022/0230222 A1
(43) Pub. Date: Jul. 21, 2022

(54) Systems and Methods of Generating Insights Into Datasets

(71) Applicant: ListReports, Inc., Orange, CA (US)

(72) Inventors: Matthew Kirkpatrick Duffy, Nashville, TN (US); Ajay Vinod Shah, Orange, CA (US); Randolph Vernon Shiozaki, Chino Hills, CA (US); David Duane Elkins, Irvine, CA (US); Beau Jensen Walker, Irvine, CA (US); Jacob Alan Dodd, Aliso Viejo, CA (US)

(21) Appl. No.: 17/646,460

(22) Filed: Dec. 29, 2021

Related U.S. Application Data
(60) Provisional application No. 63/137,986, filed on Jan. 15, 2021.

(51) Int. Cl. G06Q 30/06; G06Q 30/02; G06Q 50/16

(52) U.S. Cl. CPC G06Q 30/0629; G06Q 50/16; G06Q 30/0206; G06Q 30/0205

(57) ABSTRACT

Systems and methods of the inventive subject matter are directed to generating insights into user-selected items based on a cohort of related items. In embodiments, users access a platform server and subsequently make a selection (e.g., the user selects a home listing). The platform server then identifies similar home listings to populate a cohort. Once the cohort is generated, statistics based on that cohort can be determined, and one or more of those statistics can then be used by the platform server to deliver an insight into the user-selected item. For example, if a user selects a home listing in a certain zip code, the platform server could alert the user that the selected home listing is more expensive than 75% of related listings, where the 75% value is calculated using the cohort of related home listings that is generated after the user selects the home listing.

This application claims priority to U.S. Provisional Patent Application Ser. No. 63/137986, titled “Intelligent Property Purchasing System”, filed Jan. 15, 2021. All extrinsic materials identified in this application are incorporated by reference in their entirety.

### FIELD OF THE INVENTION

The field of the invention is dataset insight generation.

### BACKGROUND

The background description includes information that may be useful in understanding the present invention. It is not an admission that any of the information provided in this application is prior art or relevant to the presently claimed invention, or that any publication specifically or implicitly referenced is prior art.

As large datasets are made increasingly more available and easier to access, there arises a need to use that data as effectively as possible. One way to look at a dataset involves simply generating statistical analyses to learn, for example, mean, median, mode, standard deviation, and so on. But those statistics are not always particularly useful.

For example, in the context of buying a home, a person may be looking at a home listing. When a person accesses a home listing, they are typically accessing information stored in a multiple listing service (MLS) database. But these databases typically hold raw data that is added by, for example, real estate agents. Access to raw data can be useful, but the power of having access to a large database—or several large databases—can be harness much better by putting into place systems and methods that can interpret those large datasets.

It can be advantageous, for example, for a user to be presented with relevant information about a home listing when accessing that listing. This presents several challenges including how to select what information is relevant enough to present as well as determining how best to present that relevant information to maximize its usefulness. A need therefore exists for systems and methods capable of presenting useful information to users, the information relating to large datasets based on user selections and actions.

It has yet to be appreciated that systems and methods of data selection, interpretation, and presentation to end users can be dramatically improved upon.

### SUMMARY OF THE INVENTION

The present invention provides apparatuses, systems, and methods in which insights into real estate related people and items such as home listings. In one aspect of the inventive subject matter, an insight generating method is contemplated, the method comprising the steps of: receiving, at a platform server, a user selection from a user device, the user selection comprising a target listing, the target listing including a home listing that is associated with a set of attributes; generating, by the platform server, a cohort of property listings according to cohort settings and related to the user selection by identifying a set of property listings based on at least one attribute from the set of attributes associated with the home listing, where each property listing in the cohort is associated with a second set of attributes; using the second set of attributes for each property in the cohort to generate at least one cohort-level statistic; selecting, by the platform server, an insight template based on the at least one cohort-level statistic; generating, by the platform server, an insight using the at least one cohort-level statistic and the insight template; and sending the insight to the user device.

In some embodiments, at least one cohort-level statistic comprises a value between 0 and 100%. The insight template can be selected based on the value, and the value falls within a range of 0%-25%, 25%-75%, and 75%-100%. In some embodiments, the insight template comprises template text that includes a replaceable field, where the replaceable field is configured to be replaced with the at least one cohort-level statistic. The insight template can include one or any combination of a stat direction, a Boolean insight, and a continuous insight.

In another aspect of the inventive subject matter, an insight generating method is contemplated, the method comprising the steps of: receiving, at a platform server, a user selection from a user device, the user selection comprising a target home listing that is associated with a set of attributes, where the set of attributes includes a location, a price, a square footage, a number of bedrooms, and a number of bathrooms; generating, by the platform server, a cohort of home listings related to the target home listing by identifying a set of property listings based on at least one of the location, the price, the square footage, the number of bedrooms, and the number of bathrooms, where each property listing in the cohort is associated with a second set of attributes and where the second set of attributes includes a second location, a second price, a second square footage, a second number of bedrooms, and a second number of bathrooms; generating a cohort-level statistic using an attribute from the second set of attributes for each property in the cohort; selecting, by the platform server, an insight template based on the cohort-level statistic; generating, by the platform server, an insight using the cohort-level statistic and the insight template; and sending the insight to the user device.

In some embodiments, the cohort-level statistic comprises a value between 0 and 100%. The insight template can be selected based on the value, and the value falls within a range of 0%-25%, 25%-75%, and 75%-100%. In some embodiments, the insight template comprises template text that includes a replaceable field, where the replaceable field is configured to be replaced with the cohort-level statistic. The insight template can include one or any combination of a stat direction, a Boolean insight, and a continuous insight.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a schematic diagram showing how individuals input data to a first server and how users access that data via a platform server.

FIG. 2 is a schematic showing how cohorts are generated.

FIG. 3 is a schematic showing how insights are generated using information from a cohort.

FIG. 4 shows an example breakdown of statistical categories.

FIG. 5 is a flowchart of an example of a user accessing a platform of the inventive subject matter and receiving an insight based on a user selection and that user's profile.

FIG. 6 is a flowchart of an example of a user accessing a platform of the inventive subject matter and receiving an insight based on a user selection.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

Also, as used in this application, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements. Moreover, and unless the context dictates the contrary, all ranges set forth in this application should be interpreted as being inclusive of their endpoints and open-ended ranges should be interpreted to include only commercially practical values. Similarly, all lists of values should be considered as inclusive of intermediate values unless the context indicates the contrary.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Embodiments of the inventive subject matter are directed to systems and methods that facilitate creating and delivering information to end users such as potential home buyers. Many different databases currently exist to store information about properties for sale. For example, there exist many MLS databases, and hundreds of these databases and other similar real estate databases currently exist in the United States alone. These databases store property specific information like address, number of bedrooms and bathrooms, lot size, and so on.

But while raw data about an individual property can be useful, it has been discovered that real estate data can be more useful when large datasets are used to generate useful insights into a specific property, where those insights are developed using data from a set of property listings. Generating these insights requires new systems and new data structures. This application is directed to the generation of property insights, including the computing and data transfer architectures needed to make such systems and methods a reality.

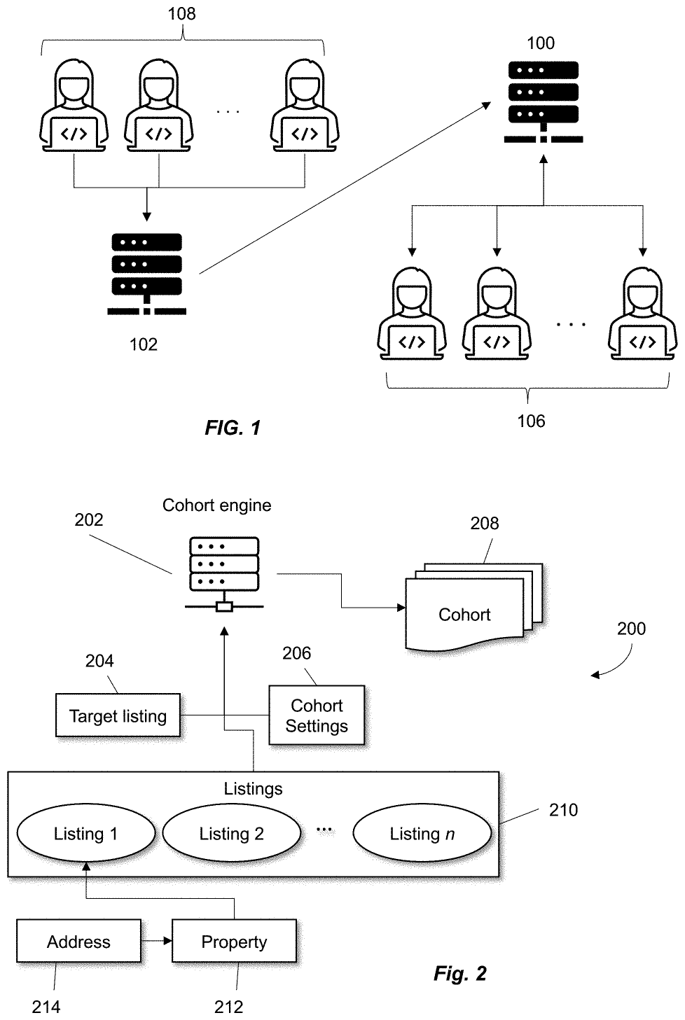

FIG. 1 shows broadly how a platform server 100 of the inventive subject matter can retrieve information from property information servers 102 (e.g., MLS databases or the like that are stored on one or more servers). Information about properties is input into property information servers 102 from a variety of different sources, including real estate agents (depicted above property information servers 102 as data entry users 108). That information is stored to databases in property information servers 102. Although property information servers 102 and the platform server 100 are represented by single icons in FIG. 1, it should be understood that property information servers 102 and the platform server 100 can include many different servers that can all be run and managed independently from one another.

Data stored in property information servers 102 can include location, type of property (e.g., single family, lease, vacant land, duplex), property features (number of bedrooms and bathrooms), price ranges, and so on. In addition to the data itself, metadata can also be included. For example, a date and time the data was added, a duration of time the data has existed on the server, an identity of an individual the data is associated with (e.g., a seller's agent or agency), etc. Using this data, and more, insights into different property listings can be generated. Platform server 100 can then access property information servers 102 to pull or read data and to make that data—and insights into that data—accessible to its users 106.

Insights of the inventive subject matter comprise information about a “target” listing in relation to a cohort of listings that are related to the target. For example, an insight could be, “This listing is a steal—it has a lower price than 75% of related listings in the area.” To generate and deliver insights, a cohort of similar selections (e.g., listings) must be generated.

Systems and methods of the inventive subject matter determine which insights to show, and when, in several ways. In some embodiments, which insight to generate is based on a placement of that insight within a product implementing the inventive subject matter. For example, if a product designer determine that a particular page should show insights that relate to home size, price, etc., then only those insights are shown on that page. In another example, insight “strength” (e.g., a measure of how interesting or unique an insight is) is assessed based on a set of insights. Thus, an insight that a home is the least expensive of all similar homes, but has the largest square footage, would be a “stronger” insight than an insight that this home has an average price of similar homes. Another way to determine which insights to generate and delivery to a user is to generate and deliver insights based on items that a user has indicated they are interested in in their user profile. For example, a user may indicate interest in staying in budget, so that user could then be shown price related insights. In another embodiment, one or more machine learning algorithms can be used to determine the type of insights that would lead to a user becoming more or less interested in a home, as indicated by their behavior while interesting with that embodiment of the inventive subject matter, and then the user could be, e.g., delivered insights that increase interest.

Although the following examples are related to property listings, it is contemplated that embodiments of the inventive subject matter can be directed to other items or people related to home buying, such as buyers' agents, sellers' agents, underwriters, brokers, loan officers, any other person or item that is stored in various real estate databases, etc. To create an insight related to a target property, a cohort of similar properties must be generated. Properties in a cohort related to a target can be related by, e.g., distance, characteristics (number of bedrooms, bathrooms, pool, number of garages, etc.), and so on. Thus, a cohort can be a set of property listings related to a target property listing because each property in the set of listings has similar geographic locations, similar price points, similar type (e.g., if the target is a townhome, the cohort could be made up of other town home listings), as well as similar property attributes such as bathrooms, bedrooms, square feet, amenities (e.g., pool, garages, etc.).

Generating a cohort requires determination of what properties are related to a target listing. A platform server of the inventive subject matter thus uses a combination of filtering and similarity calculation logic to determine which listings in an area are related to a target. After applying filters to find this first set of related listings, a similarity between the listings and the target listing can be calculated. Similarity calculation can include, e.g., any combination of fields and weights to apply to each field. Some contemplated fields include price, square feet per bedroom, bathrooms, lot size, number of garages, number of floors, presence of air conditioning, price per square foot, etc. After similarity is calculated, remaining candidates are then “pruned,” and outliers can be removed. Those listings that are removed are those that were not sufficiently similar according to similarity calculations.

FIG. 2 shows, schematically, a cohort engine 202 that can generate cohorts based on a target listing 204 and cohort settings 206. The features shown and described in FIG. 2 are carried out by software code stored on, e.g., the platform server. Cohort engine 202 is used to filter candidates, perform similarity calculations, detect outliers, and prune listings from a cohort. To do this, cohort engine 202 receives a target listing 204 and cohort settings 206. Target listing 204 features a variety of attributes, including, e.g., price, date, price per square foot, property attributes, address attributes, etc. Cohort settings 206 can include, e.g., min/max price, min/max bedrooms, min/max bathrooms, distance, property subtype (condo, townhome, single family home, etc.), features and weights, etc.

Once cohort engine 202 receives a target listing 204 along with cohort settings 206, it can create a cohort 208. Cohort 208 exists as a subset of listings from a set of listings 210. Listings 210 can be stored either on the platform server, or it can be stored in a database (e.g., an MLS database or another real estate database) that the platform server can access. Each listing in the set of listings 210 can include details about the listing such as price, date listed, price per square foot, all of which can be contained in a listing's property attributes 212 and address attributes 214. Listings in set of listings 210 are shown as being numbered 1, 2, . . . , n to indicate the set can have any number of listings where n≥0. In some embodiments, a listing has attributes outside of property attributes and address attributes, as well. Property attributes can include an address, a number of bedrooms, whether there is a pool, square footage, lot size, attached garage, etc., and address attributes can include street name, street direction, state, zip code, city, neighborhood, days on market, property dimensions, home dimensions, property relationship to adjacent homes, amenities (e.g., pools, ponds, gardens, gym, guest house, foliage, fencing, driveway dimensions, topography, or any other information that can be electronically received from a conventional listing or database), previous offers, historical tax data, any attribute derived from an Al analysis, etc.

One challenge for cohort engine 202 is that it can generate a cohort that includes one or more outliers. A listing can be an outlier on the basis of any number of its attributes, such as its price, location, square footage, etc. A listing can also be an outlier if it's attributes don't match a user's preferences. For example, if a user conducts a search for houses in one zip code, but a listing is added to a cohort from a nearby zip code, that listing can be considered an outlier because it is in the wrong area according to the user's selection. One way to account for outliers is to apply a weight when performing similarity calculations, where the weight can be based on a user's preferences. For example, if a user indicates that location is the most important attribute, location can be given more weight than home type or number of bedrooms.

The number of listings placed into a cohort can also be variable. In some embodiments, a set number can be implemented (e.g., 5, 10, 20), where fewer than the set number can be added to a cohort when insufficient listings exist to fill out the cohort completely. Cohorts can also be generated iteratively to, e.g., isolate listings within different distances of a target listing (e.g., within 1 mile, then 3 miles, then 5 miles, then 10, then 20, and so on until the cohort becomes large enough to generate meaningful insights). Whether a cohort can be considered “large enough” depends on several factors including location, though typically once a cohort includes 10-30 items, it is large enough. In some embodiments, users can define how many cohort members are in a cohort. Having too few or too many members of a cohort can impact how meaningful an insight is. In embodiments where a cohort cannot be generated because no listings similar enough to the target listing exist, an insight can state, “One of a kind!” or a similar message indicating the target listing is unique in at least the sense that no similar listings are nearby.

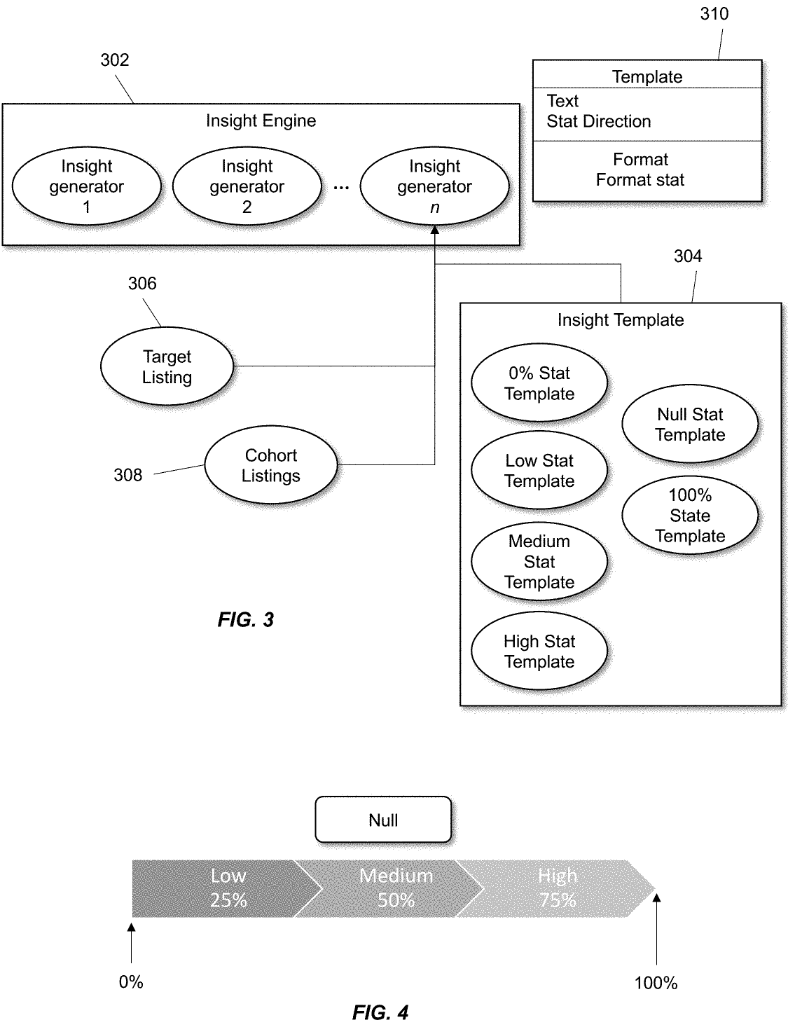

Once a cohort is generated as describe above, an insight can be generated. FIG. 3 shows an insight engine schematic, where the insight engine similarly exists as software code run on the platform server. Insight engine 302 is able to generate any number of insights related to a target property. For example, insight engine 302 is shown as having a set of insight generators at its disposal, where each insight generator relates to a particular field (e.g., bedrooms, bathrooms, price, lot size, etc.). These insight generators are shown as Insight generator 1, Insight generator 2, through Insight generator n, where n≥−1 (in other words, the insight engine can have one or more insight generators at its disposal).

Two different types of insights are contemplated: continuous and Boolean. A continuous insight is one dealing with a non-binary set of values, such as square feet or price, and a Boolean insight is one dealing with a binary condition such as TRUE/FALSE to the question “does the property have a pool?” Examples of fields that can have insights generated about them include number of bedrooms, number of bathrooms, square footage, lot size, year build, price per square foot, has pool, has attached garage, time on market, etc.

To create a more natural language feel to an insight, insight templates can be implemented and used. For example, if an insight is generated based on a target listing's price, the insight could read, “This is the cheapest property among similar properties,” or if the insight is generated based on square footage, the insight could read, “This property has more living area than 76% of similar properties.”

To create this kind of plain language formatting, template text can include replaceable fields. For example, the template text could state, “This property is more expensive than {statistic}% of similar properties,” where {statistic} is replaced by a number represented as a percent. A challenge associated with presenting statistical information is that there are two ways to describe a statistic. For example, one could say a home is more expensive than 25% of similar homes, or one could say a home is cheaper than 75% of similar homes. The latter can be preferable, and systems and methods of the inventive subject matter can be configured to present a statistic from either perspective. Thus, insight statistics can also be shown as an inverse. For example, instead of displaying, “This property has more square feet than 87% of similar properties in the area,” an insight could instead state, “Only 13% of similar properties have more square feet.”

The type of template used for an insight can be determined according to an insight statistic's category. FIG. 4 shows different statistical categories, ranging from 0% to 100%, where 0%-25% is low, 25%-75% is medium, and 75%-100% is high. These ranges can vary according to different embodiments. For example, in some embodiments, the low range can be 0%-33%, the medium range 33%-66%, and the high range from 66%-100%. Each boundary can be varied by some amount, e.g., +/−10%. This scale can thus be used to put different insights into different categories based on whether an operative value (e.g., expressed as a percent) fits into a low, medium, or high category. FIG. 4 also shows a null category, which can be used when an insight does not have a percent value associated with it. Having templates for different statistical categories allows for smarter, more flexible, customizable, and more informative insights to be generated.

Thus, for each field (e.g., bedrooms, bathrooms, price, square footage, etc.), insight engine 302 can determine an insight generator to use, and, depending on the statistical category the value for that field fits into, insight engine 302 also determines which insight template 304 to implement. Insight templates 304 are shown to include a 0% stat template, a low stat template, a medium stat template, a high stat template, a 100% stat template, and a null stat template, each of these corresponding to statistical value ranges described above in FIG. 4.

In some situations, a field is selected for an insight that does not have a corresponding insight generator in the insight engine. This can be accounted for by using a generic template based on the data type (e.g., a first generic template can be used for a continuous data type and a second generic template can be used for a Boolean data type).

Thus, each of a target listing 306, a cohort of listings 308, and an insight template are passed to the insight engine 302, where the appropriate insight generator is used to generate an insight according to an insight template 310. Insight template 310 shows text, stat direction (meaning normal stat presentation or inverse stat presentation), format (e.g., data format), and format stat (e.g., the stat will be shown as a percent). Insight templates can be stored in a database on platform server (e.g., in a PostgreSQL database). In embodiments where a client device accesses the platform server via application, it is contemplated that the application can pull and cache insight templates from a database on platform server.

In some embodiments, an insight can include multiple fields. Multiple field insights allow a user to look at how, e.g., different aspects of a property interact to give new and useful information about that property. A multiple field insight can contain all the same elements of a single field insight, with a few additions. This can be accomplished in several ways. In some embodiments, the platform server can create a “sub-cohort” by filtering by a specific feature (e.g., a cohort is generated, and then a sub-cohort is generated from that cohort using a filter). An example of a multiple field insight is: “Among properties with a pool, this property has more living area than 90%!” The two fields in this example are a field indicating that a pool exists and a field having a stat relating to living area. Thus, a cohort is built and then a sub-cohort is generated by filtering for properties with a pool. Statistics in multiple field insights can be calculated using two or more fields across an entire cohort. Creating a sub-cohort is not always required. In another example, a multiple field insight could say: “90% of similar properties have less square footage and fewer bedrooms.” In this example, a number of properties having fewer bedrooms and less square footage than the target property is calculated across the entire cohort.

Table 1, below, shows a template for a single field insight. It includes names, data types, descriptions, and examples for each. A “Field,” for example, is a “Text” data type used to describe the field to use from a cohort of fields such as [bedrooms], where the “[bedrooms]” identifies the variable associated with a number of bedrooms. A “Display Field” is another “Text” data type, and it is a front-facing field value. For example, if a field is [has_pool], then the Display Field could be [pool], because [has_pool] would be a Boolean set to either “TRUE” or “FALSE,” neither of which would be of much use to display to a user. “Threshold from media” is “Float” data type, and it can be used to determine areas about around some number value between 0 and 1, which is used to differentiate between a [high] vs. a [low] template. “Insight data type” is a “Text” data type and it provides an insight statistics category, such as [high], [low], [medium], [zero], [hundred], [none]. This can be used to describe, for example, a property's price as “High” relative to other properties. “Reverse stat” is a “Bool” data type (i.e., Boolean), and it can be used to indicate whether to show a stat that ranges from 0-1 as 1 minus that state to invert it. A reverse stat for 0.78, for example, would be 0.22 (1−0.78=0.22). Finally, “Template Text” is a field that refers to the contents of Table 2, below.

TABLE 1

| | Data | | |
|---|---|---|---|
| Name | Type | Description | Example |
| Field | Text | Field name to use from cohort, see | [bedrooms] |
| | | values in [insight_field] table | |
| Display | Text | Front facing value for field, such as | price |
| Field | | [pool] instead of [has_pool] | |
| Threshold | Float | Areas bound around 0.5 which | 0.1 |
| from media | | determines what is a [high] vs [low] | |
| | | template | |
| Insight data | Text | Insight statistics category, [high], | [high] |
| type | | [low], [medium], [zero], [hundred], | |
| | | [none] | |
| Reverse stat | Bool | Whether to show the stat (e.g., 0.78) | TRUE |
| | | as 1 - stat instead. This is for fields | |
| | | where lower is “better” than higher, | |
| | | for example, price. We want to show | |
| | | lower stat is favorable, so instead of | |
| | | presenting “this listing has a higher | |
| | | price than 22%” we'd say “this | |
| | | listing is cheaper than 78%” | |
| Template | | See template text field | |
| Text | | | |

TABLE 2

| | Data | |
|---|---|---|
| Name | Type | Description |
| Text | Text | Text to format with info from insight |
| Type | Text | Insight statistics category, [high], [low], |
| | | [medium], [zero], [hundred], [none] |
| Insight | Int | ID of template |
| template ID | | |

Table 2 shows template texts with associated data types and descriptions. For example, it includes “Text” of a “Text” data type, where “Text” includes written text that can be formatted with information from an insight. “Type” is a “Text” data type that can be used to select an insight's statistic category, such as [high], [low], [medium], [zero], [hundred], [none]. Thus, when an insight is generated using information from an insight built using an insight template from Table 1, that information is conveyed to a user by template text from an insight from Table 2.

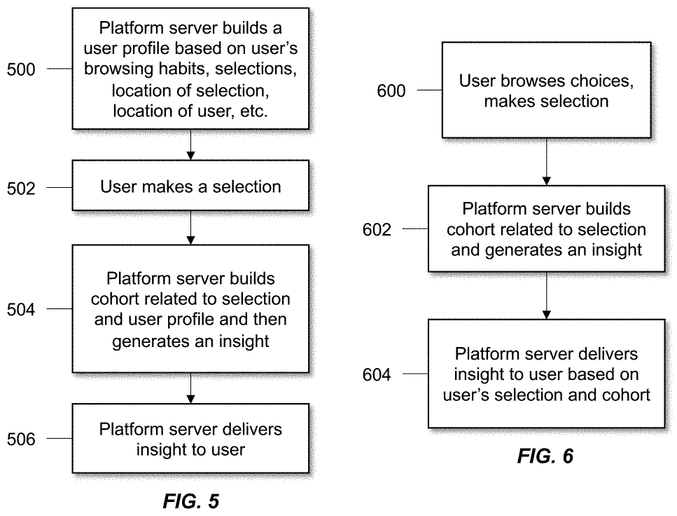

Putting everything discussed above together, insights can be generated and sent to client devices according to a variety of different parameters. FIGS. 5 and 6 show two examples in flowchart form of how insights can be generated and delivered to a user according to embodiments of the inventive subject matter.

FIG. 5 shows an embodiment where a user's actions on a website implementing an embodiment of the inventive subject matter are used to create a user profile based on the user's browsing habits and actions and then uses that information when generating a cohort based on the user's selection. FIG. 6 shows a simplified embodiment where the platform server creates a cohort based on a user's selection.

Looking first at FIG. 5, a user would first typically log into a website to access a platform server via the website. By logging in, many of that user's actions can be tracked for later use. The step of logging in is considered optional in all embodiments described in this application. In some embodiments, cookies or other tracking tools can be used in association with the steps described below.

As a user performs various actions while logged into the website (or at large on various websites in instances where cookies are used) the platform server accesses those actions to create a user profile. Actions undertaken and logged to create a user profile can depend on the type of user (agent, buyer, seller, loan officer, etc.), which can also be stored to a user's profile. User type can be defined by a user, or, in some embodiments, user type can be determined based on actions taken (e.g., by looking at what a user accesses while using the platform). If a user is a buyer, for example, that user could begin searching through home listings using various filters, such as square footage, number of bedrooms, and number of bathrooms. Each time a user conducts a filtered search, those filter settings can be stored for that user as well as metadata about the searches (e.g., time of day, number of searches, frequency of searches, etc.). Filters can be groups in a variety of ways. For example, there can be geography filters (e.g., neighborhood, zip code, city, etc.), home attribute filters (e.g., square footage, price, number of bedrooms, etc.), neighborhood filters (e.g., proximity to schools, parks, etc.), and so on. Any one or combination of these filters can be used in cohort creation as described in more detail below.

Thus, in step 500, the platform server creates a profile for the user using information about the user's browsing habits, past selections, filtering settings, etc. Users can also supplement their profile by entering additional information such as a current location, a location where they are interested in browsing property listings, preferred property types, etc. With a user profile created, the platform server can then begin to deliver useful information to the user for subsequent selections. A user thus makes a “target” selection according to step 502. A target selection can be, e.g., a listing that the user clicks on to access more information about that listing. In some embodiments, the target selection can be a seller's agent, a buyer's agent, or another individual that can be associated with a home sale or purchase, which can lead to insights being generated about or related to those individuals instead of insights about or related to a home listing.

In step 504, the platform server uses a user's profile in combination with a user's selection (e.g., a target listing) to generate a cohort related to that selection. Cohort generation is carried out as described above, and once a cohort is created, insights can be generated into the user's selection. Listings in a cohort related to a target can be related by, e.g., distance, property characteristics (number of bedrooms, bathrooms, pool, number of garages, etc.), and so on.

As discussed in additional detail above, insights of the inventive subject matter comprise information about a target selection in relation to a cohort of items that are related to the target. Items and targets in this context can be property listings, real estate agents, underwriters, or, as described above, any person or item stored in a real estate database. The following discussion focuses on an example where the target is a home listing.

A cohort in an example where a user selects a target listing is a set of listings related to the target listing because the related listing have similar geographic locations, similar price points, similar type (e.g., if the target is a townhome, the cohort could be made up of other town home listings), as well as similar property attributes such as bathrooms, bedrooms, square feet, amenities (e.g., pool, garages, etc.). This is not an exhaustive list of attributes that can be considered when generating a cohort. Generating a cohort thus requires determination of what properties are related to the target listing. A platform server of the inventive subject matter can use a combination of filtering and similarity logic to determine which listings in an area are related to a target.

In the step of building a cohort (e.g., steps 504 and 602, below), the platform server, in some embodiments, additionally generates statistics about that cohort before delivering any insights. It can be advantageous for the platform server to generate a wide range of statistics about a cohort so that whatever insight is ultimately generated and delivered to the user can draw from any of the generated statistics. Generating statistics about a cohort before delivering any insight can also help the platform server to determine which insight will be most useful for a user as it facilitates comparison of different field insight values. For example, the platform server could generate a statistic that states a percent of homes in the cohort that have pools, and if the platform server determines the user would benefit from seeing that insight (e.g., because that user frequently searches for listings that have pools), the platform server could then deliver that insight to the user. In some embodiments, statistics are generated on demand. In another example, in the same situation above regarding pools, the platform server could determine the user would benefit from an insight telling the user how many pools exist in the cohort and then calculate that percent before delivering it.

In embodiments where statistics about a cohort are generated before any insights are generated and delivered, many different statistics for an individual field can be generated to yield a field summary. Information from a field summary (e.g., one or more items from the summary) can be selected to generate an insight. For example, for a given field (e.g., price, square footage, price per square foot, lot size, bathrooms, bedrooms, year built, etc.), stats can include (the parenthetical examples that follow are related to price): an overall summary (e.g., “Price ranges between $550,000 and $960,000, with an average of $724,666.6 and median of $699,500”), a count (e.g., an integer value indicating the number of listings in the cohort), a mean (e.g., $724,666.67), a standard deviation (e.g., $172,957.41), a minimum (e.g., $550,000), a 25% value (e.g., $575,000), a 50% value (e.g., $699,500), a 75% value (e.g., $854,000), and a max value (e.g., $960,000). The percent values can relate to percentiles. For example, if the 25% value is $575,000, that means 25% of homes are below that price and 75% of homes are above that price. With statistics and field summaries generated for a plurality of fields, the platform server can generate and deliver an insight based on which field summary or statistic the platform server determines will be the most useful for a particular user.

If a user is a potential buyer and they have been searching in a specific zip code for homes having three bedrooms and two bathrooms, the platform server can begin to deliver insights that give the user additional useful information or suggestions, such as an insight pointing out that a particular listing is priced below 70% of related listings having three bedrooms and two bathrooms based on zip code location. In another example, the user could be delivered statistics about how much larger the yard size of the selected home is as compared to homes in a cohort.

FIG. 6 shows another embodiment of the inventive subject matter where a user makes a selection, and the platform server generates an insight based on the selection. In this embodiment, a user's past activities are not weighted. Optionally, a user can log into a website to access a platform server of the inventive subject matter. In step 600, the user browses choices and then makes a selection. For example, the user could browse home listings and then select a home by clicking on the listing to see more information. In step 602, the platform server builds a cohort based on the user's selection. For example, if the user selects a three-bedroom, two-bathroom home in a certain zip code, the platform server then finds other listings that are similar (e.g., three-bedroom, two-bathroom homes in the same zip code), and in step 604, the platform server generates an insight therefrom. The insight can be, for example, that the selected home is less expensive than 75% of homes in that area, or that the home has more square footage than 90% of similar homes in that area, where the “homes in that area” is based on the cohort of listings generated based on the user's original selection.

In some embodiments, the methods described in FIGS. 5 and 6 can be blended to create additional insights. For example, the platform server can generate an insight based both on a user's profile and based on a cohort of homes generated after a user makes a selection. This could result in a user selecting a three-bedroom, two-bathroom home in a certain zip code and the platform server then generating an insight that shows the user similar three-bedroom, two-bathroom homes in the same school district that also have swimming pools. Such an insight would be generated based on the user's past searches (e.g., for homes with pools) and based on the user's current selection (e.g., the school district that covers the chosen zip code).

Although FIGS. 5 and 6 are described above in the context of home listings, it is expressly contemplated that embodiments of the inventive subject matter can also be useful for other aspects of the real estate market, including real estate agents, loan officers, real estate companies, and so on. The following example describes the inventive subject matter as shown in FIGS. 5 and 6 in the context of a buyer's agent, though it should be understood that any other participant in a real estate transaction can be substituted without deviating from the inventive subject matter.

As above, FIG. 5 shows an embodiment where a user's actions on a website implementing an embodiment of the inventive subject matter are used to create a user profile based on the user's browsing habits and actions and then uses that information when generating a cohort based on the user's selection. FIG. 6 shows a simplified embodiment where the platform server creates a cohort based on a user's selection.

Looking first at FIG. 5, a user would first typically log into a website to access a platform server via the website. By logging in, many of that user's actions can be tracked for later use. The step of logging in is considered optional in all embodiments described in this application. In some embodiments, cookies or other tracking tools can be used in association with the steps described below.

As a user performs various actions while logged into the website (or at large on various websites in instances where cookies are used) the platform server accesses those actions to create a user profile. Actions undertaken and logged to create a user profile can depend on the type of user (agent, buyer, seller, loan officer, etc.), which can also be stored to a user's profile. User type can be defined by a user, or, in some embodiments, user type can be determined based on actions taken (e.g., by looking at what a user accesses while using the platform). If a user is a buyer, for example, that user could begin searching through buyer's agents using various filters. These filters can relate to attributes of buyer's agents, including, average price of homes sold, location, number of homes sold over a period of time (e.g., days, months, years), duration of time active as a buyer's agent, and so on. Each time a user conducts a filtered search, those filter settings can be stored for that user as well as metadata about the searches (e.g., time of day, number of searches, frequency of searches, etc.).

Thus, in step 500, the platform server creates a profile for the user using information about the user's browsing habits, past selections, filtering settings, etc. Users can also supplement their profile by entering additional information such as a current location or a location where they are interested in finding a buyer's agent. With a user profile created, the platform server can then begin to deliver useful information to the user for subsequent selections. A user thus makes a “target” selection according to step 502. A target selection can be, e.g., a listing that the user clicks on to access more information about that listing. In some embodiments, the target selection can be a seller's agent, a buyer's agent, or another individual that can be associated with a home sale or purchase, which can lead to insights being generated about or related to those individuals instead of insights about or related to a home listing.

In step 504, the platform server uses a user's profile in combination with a user's selection (e.g., a target listing) to generate a cohort related to that selection. Cohort generation is carried out as described above, and once a cohort is created, insights can be generated into the user's selection. Listings in a cohort related to a target can be related by, e.g., distance, property characteristics (number of bedrooms, bathrooms, pool, number of garages, etc.), and so on.

As discussed in additional detail above, insights of the inventive subject matter comprise information about a target selection in relation to a cohort of items that are related to the target. Items and targets in this context can be property listings, real estate agents, underwriters, neighborhoods, geographies, etc. The following discussion focuses on an example where the target is a home listing.

A cohort in an example where a user selects a target listing is a set of listings related to the target listing because the related listing have similar geographic locations, similar price points, similar type (e.g., if the target is a townhome, the cohort could be made up of other town home listings), as well as similar property attributes such as bathrooms, bedrooms, square feet, amenities (e.g., pool, garages, etc.). This is not an exhaustive list of attributes that can be considered when generating a cohort. Generating a cohort thus requires determination of what properties are related to the target listing. A platform server of the inventive subject matter can use a combination of filtering and similarity logic to determine which listings in an area are related to a target.

In the step of building a cohort (e.g., steps 504 and 602, below), the platform server, in some embodiments, additionally generates statistics about that cohort before delivering any insights. It can be advantageous for the platform server to generate a wide range of statistics about a cohort so that whatever insight is ultimately generated and delivered to the user can draw from any of the generated statistics. Generating statistics about a cohort before delivering any insight can also help the platform server to determine which insight will be most useful for a user as it facilitates comparison of different field insight values. For example, the platform server could generate a statistic that states a percent of homes in the cohort that have pools, and if the platform server determines the user would benefit from seeing that insight (e.g., because that user frequently searches for listings that have pools), the platform server could then deliver that insight to the user. In some embodiments, statistics are generated on demand. In another example, in the same situation above regarding pools, the platform server could determine the user would benefit from an insight telling the user how many pools exist in the cohort and then calculate that percent before delivering it.

In embodiments where statistics about a cohort are generated before any insights are generated and delivered, many different statistics for an individual field can be generated to yield a field summary. Information from a field summary (e.g., one or more items from the summary) can be selected to generate an insight. For example, for a given field (e.g., price, square footage, price per square foot, lot size, bathrooms, bedrooms, year built, etc.), stats can include (the parenthetical examples that follow are related to price): an overall summary (e.g., “Price ranges between $550,000 and $960,000, with an average of $724,666.6 and median of $699,500”), a count (e.g., an integer value indicating the number of listings in the cohort), a mean (e.g., $724,666.67), a standard deviation (e.g., $172,957.41), a minimum (e.g., $550,000), a 25% value (e.g., $575,000), a 50% value (e.g., $699,500), a 75% value (e.g., $854,000), and a max value (e.g., $960,000). The percent values can relate to percentiles. For example, if the 25% value is $575,000, that means 25% of homes are below that price and 75% of homes are above that price. With statistics and field summaries generated for a plurality of fields, the platform server can generate and deliver an insight based on which field summary or statistic the platform server determines will be the most useful for a particular user. Insights can be delivered by a variety of means, including push notification (e.g., by app or browser), email, text message, social media platform, and so on.

If a user is a potential buyer and they have been searching in a specific zip code for homes having three bedrooms and two bathrooms, the platform server can begin to deliver insights that give the user additional useful information or suggestions, such as an insight pointing out that a particular listing is priced below 70% of related listings having three bedrooms and two bathrooms based on zip code location. In another example, the user could be delivered statistics about how much larger the yard size of the selected home is as compared to homes in a cohort.

FIG. 6 shows another embodiment of the inventive subject matter where a user makes a selection, and the platform server generates an insight based on the selection. In this embodiment, a user's past activities are not weighted. Optionally, a user can log into a website to access a platform server of the inventive subject matter. In step 600, the user browses choices and then makes a selection. For example, the user could browse home listings and then select a home by clicking on the listing to see more information. In step 602, the platform server builds a cohort based on the user's selection. For example, if the user selects a three-bedroom, two-bathroom home in a certain zip code, the platform server then finds other listings that are similar (e.g., three-bedroom, two-bathroom homes in the same zip code), and in step 604, the platform server generates an insight therefrom. The insight can be, for example, that the selected home is less expensive than 75% of homes in that area, or that the home has more square footage than 90% of similar homes in that area, where the “homes in that area” is based on the cohort of listings generated based on the user's original selection.

In some embodiments, the methods described in FIGS. 5 and 6 can be blended to create additional insights. For example, the platform server can generate an insight based both on a user's profile and based on a cohort of homes generated after a user makes a selection. This could result in a user selecting a three-bedroom, two-bathroom home in a certain zip code and the platform server then generating an insight that shows the user similar three-bedroom, two-bathroom homes in the same school district that also have swimming pools. Such an insight would be generated based on the user's past searches (e.g., for homes with pools) and based on the user's current selection (e.g., the school district that covers the chosen zip code).

Thus, systems and methods directed to creating cohorts and then generating insights into those cohorts based on at least a user selection have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. An insight generating method comprising the steps of:
receiving, at a platform server, a user selection from a user device, the user selection comprising a target listing, the target listing including a home listing that is associated with a set of attributes;
generating, by the platform server, a cohort of property listings according to cohort settings and related to the user selection by identifying a set of property listings based on at least one attribute from the set of attributes associated with the home listing;
wherein each property listing in the cohort is associated with a second set of attributes;
using the second set of attributes for each property in the cohort to generate at least one cohort-level statistic;
selecting, by the platform server, an insight template based on the at least one cohort-level statistic;
generating, by the platform server, an insight using the at least one cohort-level statistic and the insight template; and
sending the insight to the user device.

2. The method of claim 1, wherein the at least one cohort-level statistic comprises a value between 0 and 100%.

3. The method of claim 2, wherein the insight template is selected based on the value, and the value falls within a range of 0%-25%, 25%-75%, and 75%-100%.

4. The method of claim 1, wherein the insight template comprises template text that includes a replaceable field, where the replaceable field is configured to be replaced with the at least one cohort-level statistic.

5. The method of claim 1, wherein the insight template comprises a stat direction.

6. The method of claim 1, wherein the insight comprises a Boolean insight.

7. The method of claim 1, wherein the insight comprises a continuous insight.

8. An insight generating method comprising the steps of:
receiving, at a platform server, a user selection from a user device, the user selection comprising a target home listing that is associated with a set of attributes;
wherein the set of attributes includes a location, a price, a square footage, a number of bedrooms, and a number of bathrooms;
generating, by the platform server, a cohort of home listings related to the target home listing by identifying a set of property listings based on at least one of the location, the price, the square footage, the number of bedrooms, and the number of bathrooms;
wherein each property listing in the cohort is associated with a second set of attributes;
wherein the second set of attributes includes a second location, a second price, a second square footage, a second number of bedrooms, and a second number of bathrooms;
generating a cohort-level statistic using an attribute from the second set of attributes for each property in the cohort;
selecting, by the platform server, an insight template based on the cohort-level statistic;
generating, by the platform server, an insight using the cohort-level statistic and the insight template; and
sending the insight to the user device.

9. The method of claim 8, wherein the cohort-level statistic comprises a value between 0 and 100%.

10. The method of claim 9, wherein the insight template is selected based on the value, and the value falls within a range of 0%-25%, 25%-75%, and 75%-100%.

11. The method of claim 8, wherein the insight template comprises template text that includes a replaceable field, where the replaceable field is configured to be replaced with the cohort-level statistic.

12. The method of claim 8, wherein the insight template comprises a stat direction.

13. The method of claim 8, wherein the insight comprises a Boolean insight.

14. The method of claim 8, wherein the insight comprises a continuous insight.

15. An insight generating method comprising the steps of:
receiving, at a platform server, a user selection from a user device, the user selection comprising a target item, the target item having an associated set of attributes;
generating, by the platform server, a cohort of items according to cohort settings and related to the user selection by identifying a set of items based on at least one attribute from the set of attributes associated with the target item;
wherein each item in the cohort is associated with a second set of attributes;
using the second set of attributes for each item in the cohort to generate at least one cohort-level statistic;
selecting, by the platform server, an insight template based on the at least one cohort-level statistic;
generating, by the platform server, an insight using the at least one cohort-level statistic and the insight template; and
sending the insight to the user device.

16. The method of claim 15, wherein the target item comprises a real estate agent, the cohort of items comprises a cohort of real estate agents, and the set of items comprises a set of real estate agents.

17. The method of claim 15, wherein the target item comprises a loan officer, the cohort of items comprises a cohort of loan officer, and the set of items comprises a set of loan officer.

18. The method of claim 15, wherein the at least one cohort-level statistic comprises a value between 0 and 100%.

19. The method of claim 18, wherein the insight template is selected based on the value, and the value falls within a range of 0%-25%, 25%-75%, and 75%-100%.

20. The method of claim 15, wherein the insight template comprises template text that includes a replaceable field, where the replaceable field is configured to be replaced with the at least one cohort-level statistic.
